(19) United States
(12) Patent Application Publication
(10) Pub. No.: US 2012/0254774 A1
(43) Pub. Date: Oct. 4, 2012

(54) METHOD FOR MANAGING A LOCAL MESSAGING PLATFORM

(75) Inventor: Damien Michael PATTON, Palo Alto, CA (US)

(73) Assignee: Banjo, Inc., Palo Alto, CA (US)

(21) Appl. No.: 13/435,565

(22) Filed: Mar. 30, 2012

Related U.S. Application Data
(60) Provisional application No. 61/469,725, filed on Mar. 30, 2011.
(60) Provisional application No. 61/539,421, filed on Sep. 26, 2011.

(51) Int. Cl. G06F 3/01; G06F 15/16

(52) U.S. Cl. 715/758

(57) ABSTRACT

A method for managing a chat room by a computer, including assigning an identifier to a user device in response to receiving a user device location from the user device; associating the identifier with a chat room having a coverage area encompassing the location of the user device; facilitating user interaction with the chat room through the identifier; and terminating the association between the user device and the identifier in response to a change in location of the user device.

### CROSS-REFERENCE TO RELATED APPLICATIONS

This application claims the benefit of U.S. Provisional Application No. 61/469,725, filed 30 Mar. 2011, and U.S. Provisional Application No. 61/539,421, filed 26 Sep. 2011, which are both incorporated in their entirety by this reference.

### TECHNICAL FIELD

This invention relates generally to the internet messaging field, and more specifically to a new and useful method for managing a chat room messaging platform in the internet messaging field.

### BACKGROUND

There are numerous internet-based messaging systems available to users. These systems typically force users to create an account and a username and log in before each use. Such messaging systems work well for messaging other users that can be identified by username, and many social networks include messaging systems that function in this manner. Additionally, mobile computing and location data have given rise to messaging and communicating while in various locations. However, while the messaging systems enable a user to message users all over the world, the messaging systems do not provide an easy way for mobile users to communicate with those around them. Thus, there is a need in the internet messaging field to create a new and useful method for managing a local messaging platform. This invention provides such a new and useful method.

### BRIEF DESCRIPTION OF THE FIGURES

FIGS. 1A and 1B are schematic representations of a method of the preferred embodiment and a detailed representation of terminating the association between the identifier and the user, respectively.

FIGS. 2A and 2B are schematic representation of a variation of the method and a detailed representation of disassociating user activity, respectively.

FIG. 3 is an exemplary screenshot of presenting local chat rooms to a user.

FIG. 4 is an exemplary screenshot for assigning an identifier.

FIG. 5 is an exemplary screenshot of a variation of a chat room.

FIG. 6 is an exemplary screenshot of a variation of a persistent identifier.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

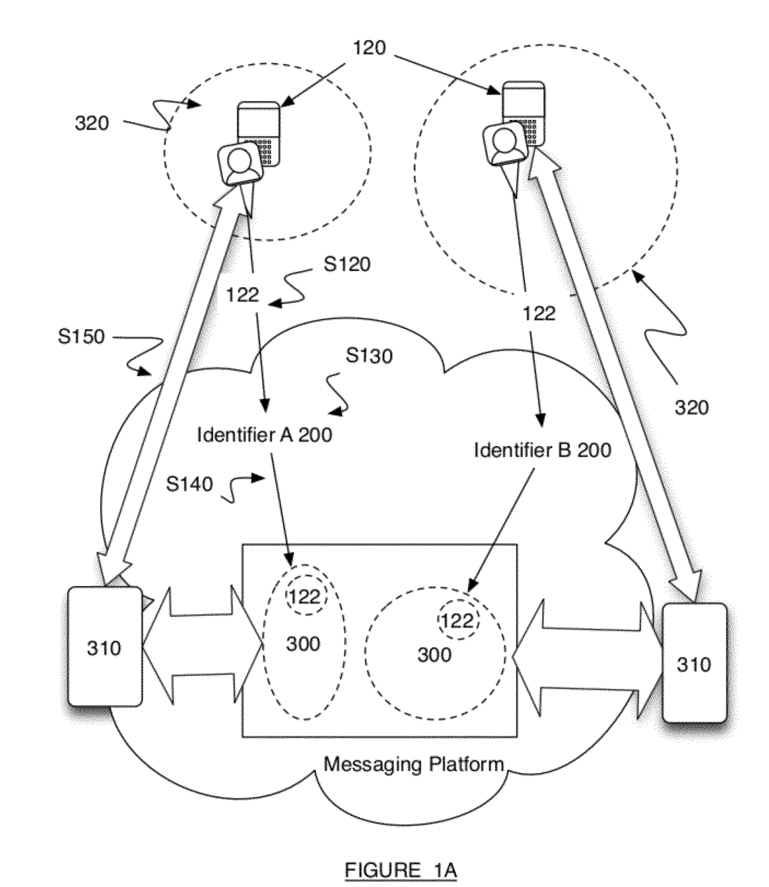

As shown in FIGS. 1A and 1B, a method for managing a local messaging platform of a preferred embodiment includes receiving a request to access a chat room S120, assigning a disposable identifier to a user S130, associating the identifier with the chat room S140, facilitating user interaction with the chat room through the identifier S150, and terminating the association between the user and the identifier S160. The method functions to create a real-time chat room for users within a defined geographical location. The method further functions to create local anonymity to enables users to easily and securely participate in a chat room. The method removes much of the invested cost in participating in a messaging platform such as creating an account, logging in, checking-in, and/or creating a digital trail. The method may additionally decouple the user from the user content generated within the system, enabling user control over the distribution and retention of content generated by the user.

The method is preferably enabled through an internet platform including one or more networked computing devices. The platform is preferably accessed via mobile computing devices such as smart phones, tablets, handheld gaming devices, laptops, or any suitable computing device to transmit messages to the messaging platform. In one variation, the messaging platform is centrally hosted by one or more servers, and interacts with a plurality of user devices. In a second variation, the messaging platform is hosted by a distributed system, wherein one or more user devices 120 may function as a user terminal, as a local server, or as both. The messaging may occur through a web application or a native application on the mobile computing device. The chat room is preferably used for real-time messaging, but may alternatively be used for posting messages in a forum setting or any suitable messaging application.

The chat room 300 utilized by the messaging system functions as an interface through which multiple users may interact. The chat room 320 preferably receives and displays chat room content. The chat room 300 is preferably associated with a coverage area 320 and a set of participation parameters.

The coverage area 320 of the chat room 320 is preferably associated with a geographic location. The geographic location is preferably defined by a longitude and latitude, and may additionally be defined by altitude. The coverage area may be a predetermined shape centered or encompassing the geographic location. For example, the coverage area can be defined by a circle centered at the location with set radius, or by a polygon defining a bounded area within a grid. Alternatively, the coverage area may be defined by a feature of an environment, such as a room within a building or the boundaries of a beach. The messaging platform can cross-reference a database to determine the type and/or shape of the environment to define the coverage area 320. The coverage area 320 may alternatively be defined in any suitable manner. The coverage area may be stationary (e.g. associated with a specific geographic location) or be mobile and move with an associated device or user (e.g. when the device functions as the server). While the coverage area 320 is preferably automatically defined by the messaging platform, the chat room coverage area 320 can alternatively be set or adjusted by a user. Additionally, the size, boundaries, and/or any other parameter of the coverage area 320 may be dynamically adjusted based on the number of nearby or adjacent chat rooms, the popularity of the location, the number of participants (e.g. shrunk or expanded to meet a user population threshold), to meet a given topic (e.g. adjusted to show a given number of users nearest the user that is associated with a topic or keyword), or adjusted based on any other suitable parameter. Alternatively, the coverage area 320 may be manually adjusted by the user, wherein the user may increase or decrease the coverage area 320 (e.g. by zooming in/out or entering a desired coverage radius); adjust the desired number of users within the chat room; or utilize any suitable method of adjusting the coverage area 320. Each chat room preferably has one associated coverage area 320, but may alternatively include multiple associated coverage areas 320, wherein each coverage area preferably includes different permissions. For example, a chat room may include a first coverage area, wherein users within the first coverage area are allowed to read and write in the chat room, and a second coverage area, wherein users within the second coverage area are only allowed to read the chat room content.

User participation within the chat room is preferably limited by a set of participation parameters. The participation parameter preferably includes user location association with the coverage area 320: users that are located within the coverage area as determined by the user location are preferably allowed to participate (e.g. read and write messages) in the chat room, and users that are not located within the coverage area cannot participate in the chat room. In one variation, users outside of the coverage area 320 may be allowed to read the messages but not write. In another variation, users that at the time of joining are within the coverage area 320 but later leave the coverage area 320 may be allowed to continue to read and write messages. Temporal rules for the chat room may also be applied. For example, if a user is outside of the coverage area for greater than an hour then that user may not be allowed to write messages in that chat room. In another variation, the chat room is associated with a member list, wherein only users within the member list are permitted access to the chat room. These users are preferably identified by an identity associated with the user, such as a Facebook, Twitter, or LinkedIn account. In another variation, access to the chat room may be limited by the device, application, or platform through which a user accesses the messaging platform. For example, a chat room may be limited to users of a particular operating system (e.g. iOS, Android, etc.) or users of a particular device (e.g. an iPhone, Blackberry, etc.). However, chat room participation may be limited by any other suitable parameter.

The user location 122 is preferably determined from the location of the user device (device location), but may alternatively be a location entered by the user, or a location otherwise determined. The user/device location 122 may be determined from the device GPS, WiFi location, accelerometer logs, etc., and can be additionally defined by an altitude. Alternatively, user location 122 can be defined by an IP address, determined from a keyword entered by a user (e.g. a unique event name) or may be otherwise determined. User location 122 may also be determined by physical proximity, wherein near-field communication technologies (e.g. RF, Bluetooth, etc.) or detection of the device on a wireless network may be used. The device location is preferably determined by the native application, but may alternatively be determined by a device API (e.g. when the messaging platform is a web application for mobile devices. The device location is preferably sent periodically to the messaging platform through a client-side application (e.g. native application or device API), but may alternatively be sent only when user-generated content is sent to the messaging platform, sent when the device tries to pull updated chat room content from the messaging platform (e.g. as a request), sent when the device location changes, sent in response to a request from the messaging platform (e.g. wherein the request is sent periodically or when information should be pushed to the device), or sent at any other suitable frequency.

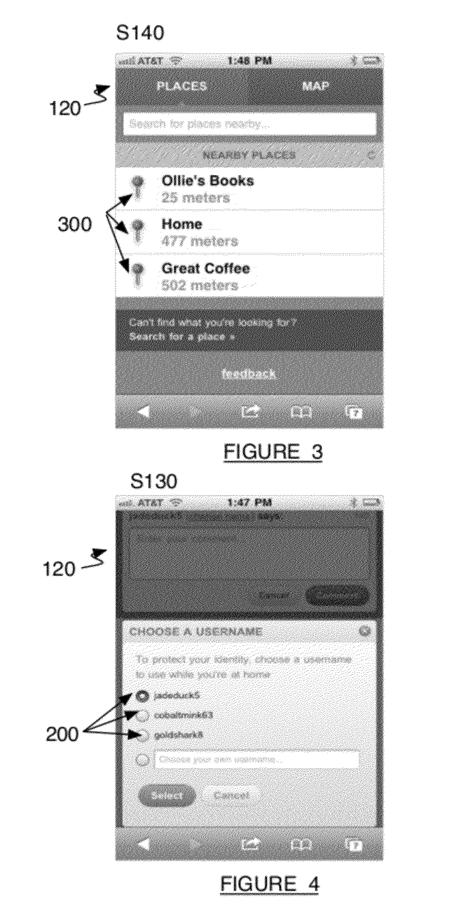

The chat room content 310 functions to communicate data about a user to other users within the chat room. The chat room content preferably includes one or more sets of user-associated content. Each set of user-associated content is preferably associated with the user identifier, and preferably includes an aggregation of user-generated content 312 for the chat room session. User-generated content 312 may include text-based messages, hyperlinks, images, videos, audio clips, timestamps, likes, dislikes, or other suitable content. The user-associated content may additionally include user location information; the user location 122 is preferably associated with a piece of user-generated content, more preferably each piece of user-generated content 312, but may alternatively be displayed in the chat room on its own. The user-associated content may additionally include a user identity should the user choose to reveal said identity. As shown in FIG. 5, the chat room content 310 is preferably displayed as a list, but may alternatively be displayed over a map or displayed in any suitable form.

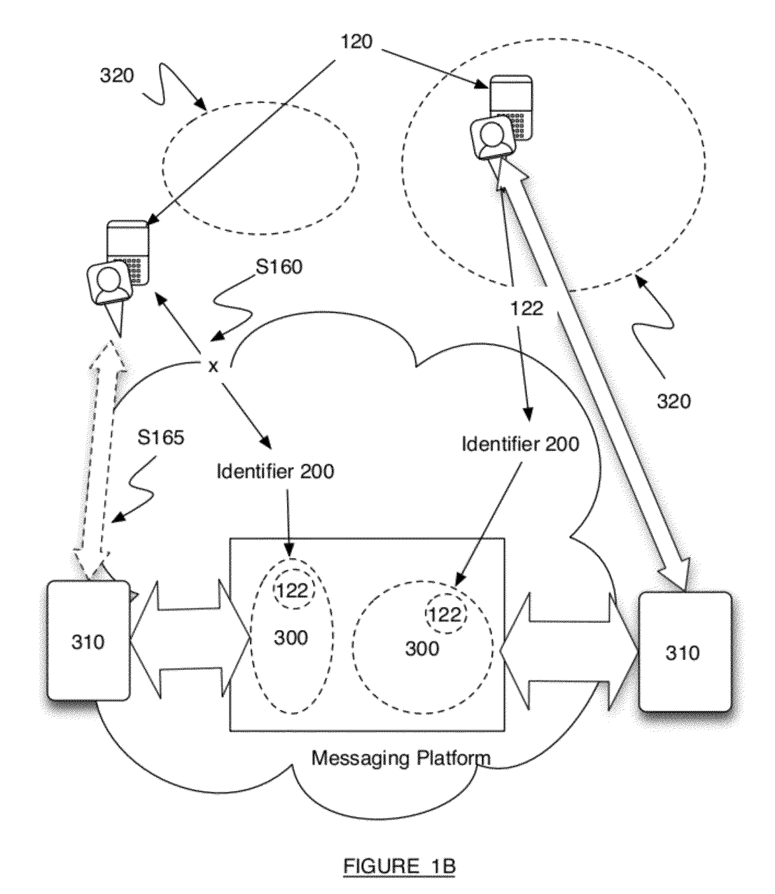

As shown in FIGS. 1 and 2, receiving a request to access a chat room S120 functions to receive a new user attempting to access a chat room of the messaging platform. The request is preferably sent by a client of a user (or alternatively, a device or application), and received by the messaging platform. The request is preferably sent upon user access of the messaging platform, but may alternatively be sent upon user selection of an action within the messaging platform (e.g. selection of a “create chat room” or “join chat room” option). The user location, more preferably, the user location 122 is preferably obtained to complete a request. The user location 122 is preferably the entire request, but may alternatively be included within the request or determined after the initial request.

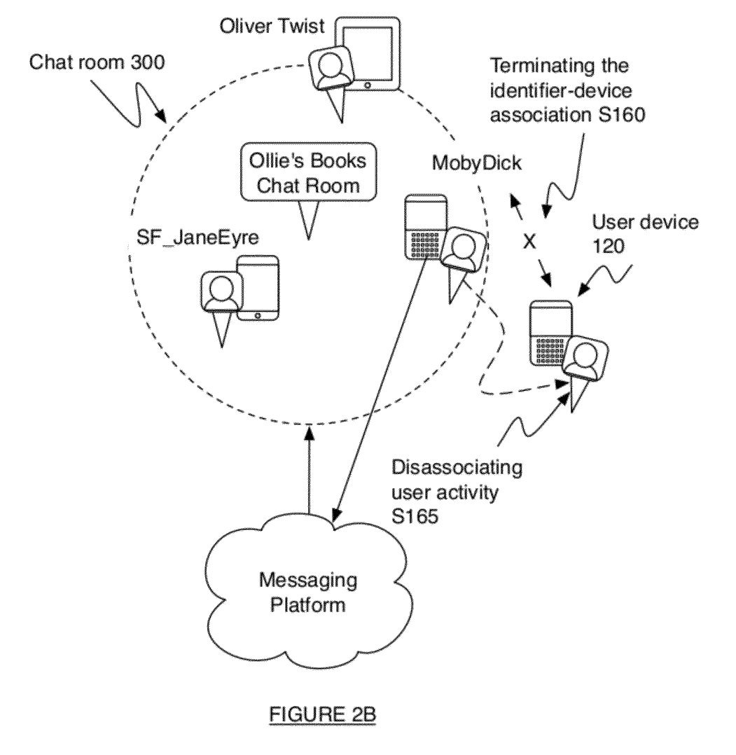

Assigning a disposable identifier to a user S130 functions to create a handle for the user as they participate in the chat room. More preferably, the identifier 200 (pseudonym) is assigned to the user device associated with the user, such that the identifier 200 is indirectly assigned to the user. Assigning a disposable identifier may be optional, and may not be necessary if a user elects to utilize a pre-established identity/persistent identifier to join the chat room. Assigning a disposable identifier may function to create anonymity for users. Assigning a disposable identifier additionally functions to create frictionless use of the chat room, since there is low risk and few steps to start participating. Identifiers 200 are preferably unique within each chat room by preventing an assignment of a duplicate identifier in a chat room. However, the same identifier may be used simultaneously across multiple chat rooms, or may be unique across the system. The identifier 200 preferably has no long term correlation to the user—it only has a short term correlation to the user during the participation in the chat room. In other words, the identifier 200 is preferably transiently associated with the user, wherein the association between the user and transient identifier 210 is preferably terminated after user logout from the chat room. However, a persistent identifier 220 may be used to identify the user if the user elects to reveal a more persistent identity. The identifier 200 is preferably automatically assigned to the user by the messaging platform upon platform access (e.g. when the user opens a platform-associated native application or accesses a platform associated web application), or receipt of the access request. The identifier 200 is preferably a handle, name, image or other identifier. The identifier 200 may be pseudo-randomly generated, selected from a list, entered by the user, or otherwise determined. In one variation, identifier assignment is automatic and performed by the messaging platform. The platform preferably pseudo-randomly assigns an identifier to the user or assigns the user an identifier from an identifier list. The identifier list may be a list of identifiers as shown in FIG. 4. The suggested identifiers can be randomly generated or locally assigned names. For example, a local bookstore can use identifiers with references to literary figures to create themed identifiers for that chat room. In a second variation, the messaging platform sends the list of available identifiers to the user device, wherein an identifier selected by the user is assigned as the identifier. In a third variation, the messaging platform assigns the device a user-input identity. Upon leaving a chat room, the identifier is preferably disassociated from the user. The user may have a different identifier each time they join a chat room. An identifier previously used in a chat room may require a set amount of time or chat room usage before that identifier may be used by a different user to prevent identity confusion. As described below, the user may alternatively elect to use an identity more permanently associated with the user. For example, a social network identity such as a Twitter username, Facebook, or LinkedIn account may be used as the identity of the user. Additionally, the user may select an identity from a plurality of identities associated with the user (persistent identifier 220). For example, the user may use one identity in professional circles and another identity in social setting like at a concert. Use of a real identity preferably requires logging in through that account. When a persistent identifier 220 is used, the persistent identifier 220 is preferably reassigned as the user identifier 200, and the user-generated content 312 associated with the disposable identifier 210 is preferably reassigned to the persistent identifier 220.

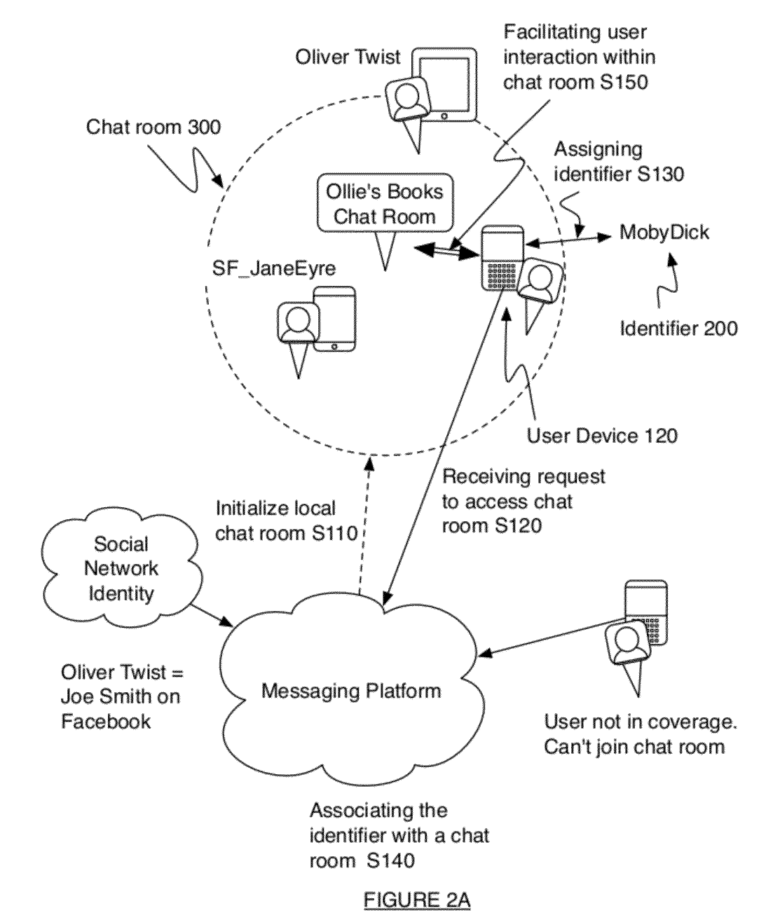

Associating the identifier with the chat room S140 functions to enable a user to participate in a chat room. The identifier 120 is preferably assigned to a chat room 300 with a coverage area 320 associated with the user location 122 that is associated with the identifier 200. The identifier 200 is preferably assigned to a preexisting chat room, but a new chat room may be initialized for the identifier if the user location 122 is outside of any preexisting chat room coverage areas, is on the edge of a preexisting chat room coverage area 320, if preexisting chat room parameters have been met, or for any other suitable initialization condition. The messaging platform preferably determines whether the participation parameters for the chat room 300 have been met. If the participation parameters have been met, for example, the coverage area of a preexisting chat room covers the user location 122, the client side application preferably presents the preexisting chat room to the user and assigns the identifier to said chat room. As shown in FIG. 3, a plurality of chat rooms that have overlapping coverage can be available to the user if the user is located in the overlapping coverage, wherein the messaging platform assigns the identifier to a user-selected chat room. The plurality of chat rooms may additionally be filtered by keywords, relationships, or any other suitable filter.

Facilitating user interaction with the chat room through the identifier S150 functions to allow the user to consume content generated by other users. Facilitating user interaction may additionally allow the user to interact with other users through the chat room. The user preferably interacts with the chat room through the assigned identifier, such that actions and content generation are associated with said identifier. As shown in FIG. 5, facilitating user interaction with the chat room preferably includes facilitating consummation of chat room content S152 and facilitating user content generation S154.

Facilitating consummation of chat room content S152 preferably includes displaying identifiers of the users located within the chat room (e.g. on a map or in a list form), locations of the users, user-generated content, user-associated content, or any other suitable content related to the users of the chat room. In one variation, as shown in FIG. 5, facilitating content consummation includes displaying content generated by users 312 in the chat room as a time-or length-limited list, summary, chart, or any other suitable display. New user-generated content received by the chat room is preferably pulled from the messaging platform by the device, wherein the device preferably requests information from the messaging platform periodically or upon receipt of a user request (e.g. selection of a “refresh” button). Alternatively, new content may be pushed to the device by the messaging platform, wherein the messaging platform pushes new content when the new content is received, or pushes the new content periodically. Alternatively, new content may be pushed to the device of the first user by the device of the content creator, which might be preferable when the messaging platform is a distributed system. Alternatively, chat room content 310 may be updated at the device in any other suitable manner.

Facilitating user interaction may additionally include facilitating content generation by the first user within the messaging platform S154, wherein the messaging platform receives content generated by the first user and adds the received content to the chat room content 310. User interaction within the chat room includes any suitable messaging capabilities, such as sending public text messages, privately messaging other members in the chat room, sharing photos, sharing videos, playing games, sharing location, and/or any suitable chat room action, as shown in FIG. 5. The messaging platform may facilitate user interaction by providing an input field (e.g. for text), integrating a posting option within another application native to the user device, providing notifications, such as push notifications, when a trigger event occurs, or may facilitate any other suitable user interaction. Examples of trigger events for push notifications include proximity of a second user associated with the first user (e.g. wherein the second user is associated with the first through a second messaging platform or social network), entrance of a second user associated with the first user into the chat room, entrance of any second user into the chat room, receipt of content directed at the first user (e.g. that directly references or links to the first user), receipt of new content by the chat room, or any other relevant event.

While participating in the chat room, a user may additionally augment chat room participation. Augmenting participation may include revealing identity to other users, Mocking other users, partitioning or splitting chat rooms, adjusting the location/coverage of a chat room, or any suitable change to rules governing participation in the chat room.

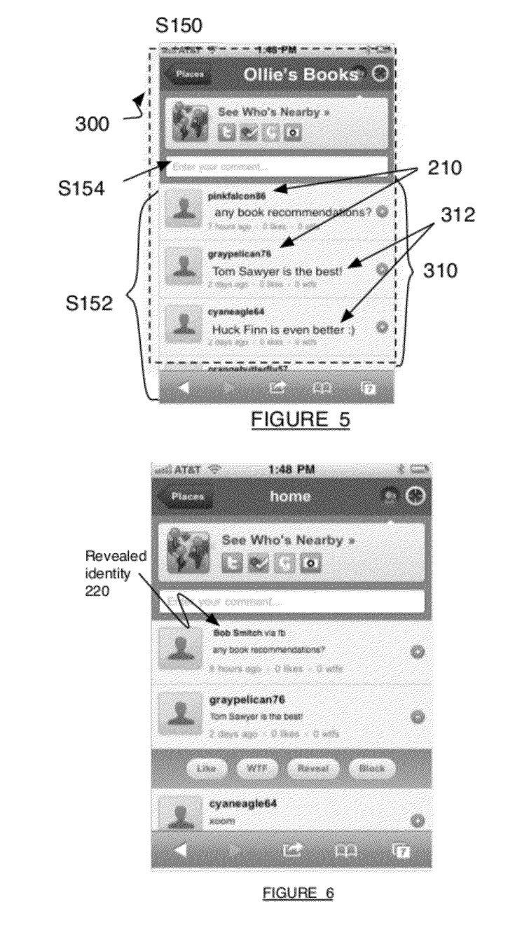

One variation for augmenting participation in a chat room includes the sub-step of revealing identity of a user, as shown in FIG. 6. To reveal identity, the user preferably uses an existing account identifier either within the messaging platform or from an outside source such as a social network like Twitter, Facebook, or LinkedIn. Preferably, a user can elect to reveal the identity to individual users also participating in the chat room. The account identifier may additionally be selected from a plurality of identifiers. The user can preferably select which account identifier to use based on the context of a chat room. Additionally, a plurality of identities may be revealed. The plurality of identities may be grouped within a profile page where a link and/or information about each identity are revealed. The user preferably selects a second user in the chat room, activates an option to reveal identity, and then selects the identity to reveal to the second user. Additionally, the user may reveal identity to all users in a chat room. Other techniques for partially revealing identity may additionally or alternatively be used. For example, an indication that the first user shares a social network connection with the second user may be communicated. The first user can then decide to reveal their full identity or not. This may allow users to more readily reveal identity to users that they already know. Revealing of identity is preferably a one-way transaction (e.g., only one user needs to reveal identity), but revealing of identity may alternatively require both users to agree and then both identities are revealed. Similarly, after revealing identity, a user may obscure an identity by returning to use of a identifier. The identifier is preferably a new identifier. The second user who learned of the identity of the user would preferably have no way of knowing the new identifier is the other user.

Another variation for augmenting participation in a chat room includes the sub-step of blocking participation of a user in a chat room, as shown in FIG. 6. A first user may decide to block a second user. Blocking the second user preferably prevents the first user from seeing activity of the second user and preferably prevents the second user from seeing activity of the first user. Selective Mocking preferably enables a second user to continue participating but without interacting with the first user. Alternatively, Mocking the second user may prevent the second user from seeing any activity in the chat room as a form of full Mocking. This full Mocking may alternatively be activated if a plurality of users block a particular user, if the particular user violates messaging rules (e.g., spamming, obscene language, etc.), or for any suitable reason. As a variation, the second user may not be simply blocked from participating but the second user may be moved, behind the scenes, to a second chat room without the participants of the first chat room. As another variation, the second user may be “banned” from re-entering the chat room for a particular time period, whether or not they use the same identifier.

As shown in FIGS. 1A and 2B, the method may additionally include terminating the association between the identifier and the user S160, which functions to disassociate the identifier 200 from the user. More preferably, as the identifier is preferably assigned to the user device, S160 functions to disassociate the identifier 200 from the device. Identifier-user relationship termination can enable greater user control over the distribution and retention of user-generated content 312. Termination of the identifier-user association preferably additionally results in inaccessibility of the chat room by the user and/or user device through the identifier. The messaging system preferably terminates the identifier-user association in response to a termination condition being met. The termination condition is preferably met when the device location changes; more preferably, when the user location 122 is determined to not be in the chat room coverage area 320 (e.g. device is not detected within the coverage area 320 or has exited the coverage area 320). As aforementioned, the user location 122 is preferably periodically sent to the messaging platform by the device, but may be sent along with user content, pulled from the device by the messaging platform, or sent by the device in response to a request from the messaging platform, wherein the requests are preferably periodically sent, but may be sent with content if new content pushed to the device. Alternatively, the identifier-user relationship may be terminated after a predetermined time period has passed after the user location 122 is determined to no longer be within the coverage area 320. Other termination conditions include: closing of the application or site on the device, identifier inactivity for set amount of time, being banned, or any other suitable condition for terminating the identifier-user relationship. After a user leaves a chat room, the identifier is preferably retired from immediate use in the chat room, which prevents a second user from using the identifier and causing confusion. The identifier can become available after a set amount of time or based on any suitable rule.

As shown in FIG. 1B, the method may additionally include disassociating user activity from the chat room upon identifier-user disassociation S165, which functions to sever the persona of the user, defined from user interactions within the chat room, from the messaging platform. A persona may include any attributes or history associated with a chat room entity, including: user-generated content, user action history, application history, application settings, identities revealed to all users, and/or any suitable parameters that may be stored during a session. The user activity is preferably disassociated from the messaging platform by automatically deleting the persona/user history in response to the identifier-user disassociation. Alternatively, history information may be stored for the chat room, but there is preferably no mapping between identifiers used in the chat room and the users they were associated with. As an alternative, history information may be stored if the user has revealed their identity. Alternatively, if the user device functions as the server, the persona associated with the user of the device is preferably retained (e.g. within the device). In this variation, the personas of other users previously within the chat room are preferably disassociated from their respective users, and may be retained or deleted.

As shown in FIG. 2A, the method may additionally include initializing a chat room S110. S110 is preferably performed in response to a determination in S140 that a new chat room should be initialized (e.g. when an initialization condition has been met), but may be initialized for any other suitable reason. The chat room is preferably associated with the simultaneous user location (e.g. centered about the user), but may be associated with the location of a nearby listing (e.g. user is included within the coverage area, but the chat room location is not centered about the user) or associated with any other suitable location. Chat rooms can alternatively be pre-established either by a system operator or by entities wishing to host a chat room. For example, a coffee shop can wish to have a chat room and create one through the messaging platform.

The method can additionally include terminating a chat room. A chat room is preferably terminated by the messaging platform when there are no associated identifiers, but may be terminated by a user, or in response to any other suitable termination event. Terminating a chat room preferably includes removing limitations, such as population limitations, blocking limitations, etc. associated with a coverage area 320.

The method may additionally include notifying a current user of the chat room about changes in the chat room parameters. Chat room change notifications may be notifications of changes in the size, boundaries, and/or any other parameter of the coverage area 320, changes in the reading/writing permissions of the chat room, changes in the popularity of the chat room, changes in the number of active participants, changes in the topic/keyword criteria (e.g. wherein the user must be associated with a given topic/keyword to be able to participate in the chat room), or any other change that affects user participation and/or inclusion in the chat room. For example, the client-side application may display a chat room change notification when the read/write coverage area is expanded to include the location of a user that was previously only allowed to read the chat room content. However, any suitable notification may be displayed in response to a change in the chat room parameters.

The method may additionally include notifying a current user of the chat room about activities of other users with “friend alerts.” Friend alerts may be notifications of activities of other users in the same social network as the user, users in the same chat room, users within a certain geographic proximity to the user, or any other suitable classification of users. Notifications may be made when one of these other users “checks in” to a certain location with their mobile device, posts a picture, posts a status update or “Tweet” (either on the application of the present invention or on a linked social network, e.g. Facebook or Twitter), updates his or her profile, changes his or her settings, posts a comment, comes within a certain geographic proximity, or any other suitable application action. In the variation involving geographic proximity, the current user may set the application to notify him or her when a certain user is within geographic proximity of his or her current location, a location selected from a group of favorites, a previous location, and the like. “Geographic proximity” may be defined by being within a certain radius of that location, by being within a shaped area such as a polygon defining a bounded area within a grid, by being inside a building/environment, or by any suitable manner to define an area for coverage. In one variation, geographic proximity may be defined by being within the same area used to define who is in a chat room.

Friend alerts are preferably customizable by the current user. The application of the present invention may have a settings module enabling the current user to set different friend alert directions for different users. For example, Joe Smith, a current user of the application, may select for the application to notify him when his close friends are within 800 meters, when friends of those friends are within 400 meters, et cetera. “Close friends” may include the users who are his Facebook friends, and “friends of those friends” may include users who are those Facebook friends' friends. Alternatively, the current user can customize notifications according to individual identities. For example, he may set the application to notify him when a friend Mary is within 1600 meters, when a friend Chris is within 800 meters, and the like.

Furthermore, the current user may set different types of notifications for different friends. Returning to the previous example, the current user may set his application to produce a sound when Mary is nearby, a pop-up window when Chris is nearby, and the like. The friend alerts settings may also be switched on or off depending on whether or not the current user is in a chat room.

An alternative embodiment preferably implements the above methods in a computer-readable medium storing computer-readable instructions. The instructions are preferably executed by computer-executable components preferably integrated with a messaging platform. The messaging platform is preferably hosted on a distributed computing platform or hosted in any suitable environment. The messaging platform preferably includes network or communication access to client devices of the users. The client devices preferably access the messaging platform through a native application or a web application. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method comprising:
at a first computer, assigning an identifier to a user device in response to receiving a user device location from the user device;
at the first computer, associating the identifier with a chat room having a coverage area encompassing the location of the user device;
at the first computer, facilitating user interaction with the chat room through the identifier; and
at the first computer, terminating the association between the user device and the identifier in response to a change in location of the user device.

2. The method of claim 1, wherein associating the identifier with a chat room comprises:
in response to determining that the user device location is located within the coverage area of a preexisting chat room, the first computer associating the user device with the preexisting chat room; and
in response to determining that the user device location is not located within the coverage area of a preexisting chat room, the first computer initializing a chat room with a coverage area encompassing the user device location.

3. The method of claim 1, wherein associating an identifier with the user device comprises: at the first computer, receiving an identifier input from the user device; and
at the first computer, associating the identifier input with the user device.

4. The method of claim 3, wherein associating an identifier with the user device further comprises: at the first computer, transmitting a list of identifiers to the user device, wherein the identifier input is an identifier selection from the list of identifiers; wherein the identifier selection is associated with the user device.

5. The method of claim 1, wherein facilitating user interaction with the chat room through the identifier comprises:
receiving content from the user device; and
presenting the identifier and the content within the chat room.

6. The method of claim 5, wherein the content comprises a persistent identity associated with the user of the user device.

7. The method of claim 6, further comprising:
assigning the persistent identity to the user device as a second identifier;
associating the content associated with the first identifier with the second identifier; and
terminating the association between the user and the first identifier.

8. The method of claim 1, wherein facilitating user interaction with the chat room through the identifier comprises:
receiving a Mocking request from the user device; and
restricting the interaction of a second identifier, associated with a second user device, with the chat room in response to the blocking request.

9. The method of claim 1, wherein termination of the association between the user device and the identifier is in response to a determination that the user device is not located within the coverage area.

10. The method of claim 9, wherein termination of the association between the user device and the identifier is in response to a determination that the user device has not been located within the coverage area for a predetermined time threshold, wherein the first computer terminates the association between the user device and identifier after the time threshold is met.

11. The method of claim 1, further comprising: at the first computer, assigning the identifier to a second user device after the association between the first user device and the identifier has been terminated and a time threshold is met.

12. The method of claim 1, wherein the identifier is associated with a chat room that both encompasses the location of the user device and permits the device type of the user device.

13. A method comprising:
at a device, sending a device location to a computer; wherein the computer, in response to receiving the device location, assigns a unique identifier to the device and assigns the identifier to a chat room with a coverage area associated with the device location;
at the device, retrieving chat room content comprising user-input content from the computer;
at the device, receiving new user-input content and sending the new content to the computer; wherein the computer, in response to receiving the new content, associates the new content with the identifier and posts the new content to the chat room with the identifier;
at the device, sending a second location to the computer; wherein the computer, in response to receiving the second location and determining that the second location is not within the coverage area of the chat room, terminates the association between the device and the identifier.

14. The method of claim 13, further comprising: at the device, receiving an identifier selection from a list of identifiers and sending the identifier selection to the computer, wherein the computer assigns the identifier selection to the user device as the unique identifier in response to receiving the identifier selection from the device.

15. The method of claim 13, wherein assigning the identifier to a chat room with a coverage area associated with the device location comprises:
at the computer, in response to determining that the device location is encompassed by a preexisting chat room coverage area, assigning the identifier to the preexisting chat room; and
at the computer, in response to determining that the device location is not encompassed by a preexisting chat room coverage area, initializing a new chat room and assigning the identifier to the new chat room.

16. The method of claim 13, wherein the computer initializes a new chat room and assigns the identifier to the new chat room with a coverage area associated with the coverage area in response to:
receiving the location from the device;
determining that the location is within a preexisting chat room coverage area; and
determining that the number of devices associated with the preexisting chat room meets a predetermined limit.

17. The method of claim 13, wherein the device sends a new device location with the new content to the computer.

18. The method of claim 13, wherein retrieving chat room content from the computer comprises: receiving, from the computer, content from a second device; wherein the computer sends the second device content to the first device in response to receiving new content from a second device.

19. The method of claim 13, wherein the content comprises a persistent identity associated with a user of the device, wherein the computer, in response to receiving the persistent identity: assigns the persistent identity to the device as a second identifier, assigns the content associated with the first identifier to the second identifier, and terminates the association between the first identifier and the device.

20. The method of claim 13, wherein the computer terminates the association between the identifier and the device in response to a predetermined time threshold being met.
